(19) United States
(12) Patent Application Publication
(10) Pub. No.: US 2014/0292680 A1
(43) Pub. Date: Oct. 2, 2014

(54) ELECTRONIC DEVICE AND METHOD FOR CONTROLLING THE SAME

(71) Applicant: Japan Display Inc., Minato-Ku (JP)

(72) Inventors: Hirofumi NAKAGAWA, Tokyo (JP); Jouji YAMADA, Tokyo (JP); Michio YAMAMOTO, Tokyo (JP); Kohei AZUMI, Tokyo (JP); Makoto HAYASHI, Tokyo (JP); Hiroshi MIZUHASHI, Tokyo (JP); Kozo IKENO, Tokyo (JP); Yoshitoshi KIDA, Tokyo (JP)

(73) Assignee: Japan Display Inc., Minato-ku (JP)

(21) Appl. No.: 14/186,198

(22) Filed: Feb. 21, 2014

(30) Foreign Application Priority Data
Mar. 29, 2013 (JP) 2013-073870

(51) Int. Cl. G06F 3/041

(52) U.S. Cl. CPC G06F 3/041
USPC 345/173

(57) ABSTRACT

According to one embodiment, the sensor-integrated display panel comprises an operation surface for operating a first sensor and a display surface of an image. The data transfer device is configured to input a driving signal for driving the first sensor to the sensor-integrated display panel and to output detection data corresponding to a potential of a sensor signal output from the first sensor. And the multi-sensor output determination module is configured to switch a processing form of the signal of the first sensor in accordance with a condition of output from a second sensor.

### CROSS-REFERENCE TO RELATED APPLICATIONS

This application is based upon and claims the benefit of priority from Japanese Patent Application No. 2013-073870, filed Mar. 29, 2013, the entire contents of which are incorporated herein by reference.

### FIELD

Embodiments described herein relate generally to an electronic device, and a method for controlling the same.

### BACKGROUND

Mobile phones, tablet computers, personal digital assistants (PDA), small-sized portable personal computers and similar devices have become popularized. These electronic devices have an operation input panel which also functions as a display panel.

The operation input panel detects a touch position where a user has touched a display surface by a change of capacitance, for example. A detection signal is input to a touch signal processing integrated circuit (IC) designed exclusively for the operation input panel. The touch signal processing IC processes the detection signal using a computational algorithm prepared in advance, converts the position touched by the user into coordinate data, and outputs the data.

In accordance with advances in manufacturing technology, the resolution and size of the display has been increased. Accordingly, because of the increase in the resolution and size, the operation input panel is required to detect a position with high accuracy. The operation input panel is also required to process data with respect to an operation input at high speed depending on applications. Further, a device capable of easily changing the applications is desired.

### BRIEF DESCRIPTION OF THE DRAWINGS

FIG. 1 is a block diagram of an electronic device according to an embodiment;

FIG. 2A is a sectional view illustrating a sensor-integrated display device including a display surface or display panel and an operation surface or operation input panel integrally;

FIG. 2B is an illustration for explaining the principle for obtaining a touch detection signal from a signal output from the operation input panel;

FIG. 3 is a perspective view illustrating sensor components of the operation input panel and a method for driving the sensor components;

FIG. 4 is a block diagram showing an example of a structure of a data transfer device shown in FIG. 1, and some of functions that are realized by various applications in an application execution device shown in FIG. 1;

FIG. 5A is a chart showing an example of output timing between a display signal and a driving signal for a sensor drive electrode which are output from a driver shown in FIGS. 1 and 4;

FIG. 5B is a schematic view illustrating an output of the driving signal of the sensor drive electrode and a driving state of a common electrode;

FIG. 6 is a 3D graph showing an example of raw data (detection data) on a sensor signal when no input operation is performed;

FIG. 7 is a 3D graph showing an example of raw data (detection data) on the sensor signal when an input operation is performed;

FIG. 8 is a block diagram showing an example of processing plural types of sensor signals in the present embodiment;

FIG. 9 is a block diagram showing an example of processing plural types of sensor signals in another embodiment;

FIG. 10 is a block diagram showing an example of processing plural types of sensor signals in yet another embodiment; and

FIG. 11 is a block diagram showing an example of processing plural types of sensor signals in yet another present embodiment.

### DETAILED DESCRIPTION

Embodiments will be hereinafter described with reference to the accompanying drawings. One of the embodiments described herein aims to provide an electronic device capable of flexibly adapting to various applications and increasing the range of input information and the use of the applications, and a method of controlling such an electronic device.

According to the present embodiment, the electronic device comprises a sensor-integrated display panel comprising an operation surface for giving an operation input to a first sensor and a display surface of an image integrally, a data transfer device configured to input a driving signal for driving the first sensor to the sensor-integrated display panel and to output detection data corresponding to the potential of a sensor signal output from the first sensor, and a multi-sensor output determination module configured to switch the processing form of the signal of the first sensor in accordance with a condition of output from a second sensor.

According to the embodiment, by using an output from the second sensor in combination with an output from the first sensor, not only an accurate determination of an operation input can be made, but also the output of the second sensor can be utilized, thereby expanding various operating functions. In addition, according to the embodiment, an application execution device enables to expand the way in which input information, such as operation inputs, is used and a function of determining the input information in many ways, so that various kinds of usage of the device as a whole can be easily broadened.

The processing form may be called as processing type, processing style, or like. The condition of output may be called as a behavior of output, a status of output, content of output, or like.

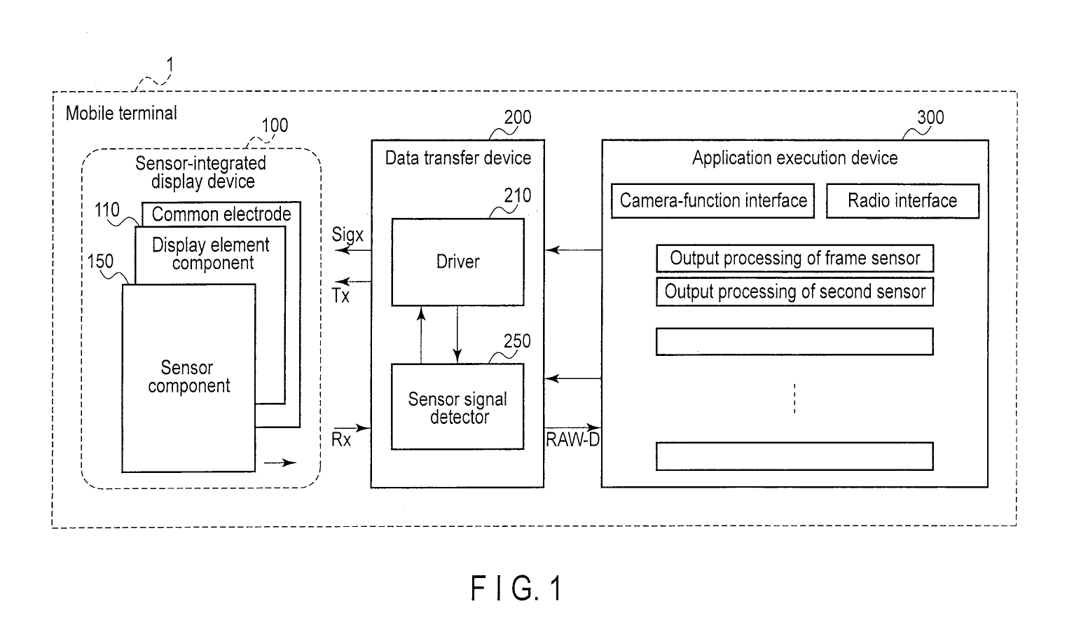

FIG. 1 shows a mobile terminal 1 to which one of the embodiments is applied. The mobile terminal 1 includes a sensor-integrated display device 100. The device 100 comprises a display surface (or display panel) and an operation surface (or operation input panel) integrally, and includes a display element component 110 and a sensor component 150 for that purpose.

The sensor-integrated display device 100 is supplied with display signal (or pixel signal) Sigx from a driver 210, which will be described later. When the device 100 is supplied with a gate signal from the driver 210, a pixel signal is input to a pixel of the display element component 110. A voltage between a pixel electrode and a common electrode is determined based on the pixel signal. This voltage displaces liquid crystal molecules between the electrodes to achieve brightness corresponding to the displacement of the liquid crystal molecules.

The sensor-integrated display device 100 is not limited to this name and may be called an input sensor-integrated display unit, a user interface or the like.

For the display element component 110, a liquid crystal display panel or display panel of light-emitting elements such as LEDs or organic electroluminescent elements may be adopted. The display element component 110 can be simply called a display. The sensor component 150 is of the capacitance change sensing type. The sensor component 150 can be called a panel for detecting a touch input, a gesture and the like.

The sensor-integrated display device 100 is connected to an application execution device 300 via a data transfer device 200.

The data transfer device 200 includes a driver 210 and a sensor signal detector 250. Basically, the driver 210 inputs to the display element component 110 graphics data that is transferred from the application execution device 300. The sensor signal detector 250 detects a sensor signal output from the sensor component 150.

The driver 210 and the sensor signal detector 250 are synchronized with each other, and this synchronization is controlled by the application execution device 300.

The application execution device 300 is, for example, a semiconductor integrated circuit (LSI), which is incorporated into an electronic device, such as a mobile phone. The application execution device 300 has the function of performing a plurality of types of function processing, such as Web browsing and multimedia processing, in a complex way, using software such as an OS.

The application execution device 300 as such performs high-speed operation and can be configured as a dual- or quad-core device. Preferably, the operating speed should be, for example, at least 500 MHz, more preferably, 1 GHz.

The driver 210 supplies a display signal (graphics data signal subjected to digital-to-analog conversion) to the display element component 110 on the basis of an application. In response to a timing signal from the sensor signal detector 250, the driver 210 outputs driving signal Tx for scanning the sensor component 150. In synchronization with driving signal Tx, sensor signal Rx is read from the sensor component 150, and input to the sensor signal detector 250.

The sensor signal detector 250 detects the sensor signal, eliminates noise therefrom, and inputs the noise-eliminated signal to the application execution device 300 as raw read image data (which may be called three-dimensional image data).

When the sensor component 150 is of a capacitive type, the image data is not two-dimensional data simply representing coordinates but may have a plurality of bits (for example, three to seven bits) which vary according to the capacitance. Thus, the image data can be called three-dimensional data including a physical quantity and a coordinate. Since the capacitance varies according to the distance between a target (for example, a user's finger) and a touchpanel, the variation can be captured as a change in physical quantity.

Below is the reason for the sensor signal detector 250 of the data transfer device 200 to directly provide image data to the application execution device 300, as described above.

The application execution device 300 is able to perform its high-speed arithmetic function to use the image data for various purposes.

New different kinds of applications are applied to the application execution device 300 according to the user's various desires. According to the condition or substance of data processing, the new applications may require a change or a switch of image data processing method, reading (or detection) timing, reading (or detection) format, reading (or detection) area, or reading (or detection) density.

In such a case, if only the coordinate data is received as in the conventional devices, the amount of acquired information is restricted. However, if the raw three-dimensional image data is analyzed as in the device of the present embodiment, for example, distance information as well as coordinate position information can be acquired.

It is desired that the data transfer device 200 be able to easily follow various operations under the control of applications in order to obtain expandability of various functions by the applications. Thus, the device 200 has a structure of being able to switch sensor signal reading timing, a reading area, a reading density or the like arbitrarily under the control of applications as simple function as possible. This point will be described later.

The application execution device 300 may include a graphics data generation unit, a radio interface, a camera-function interface and the like.

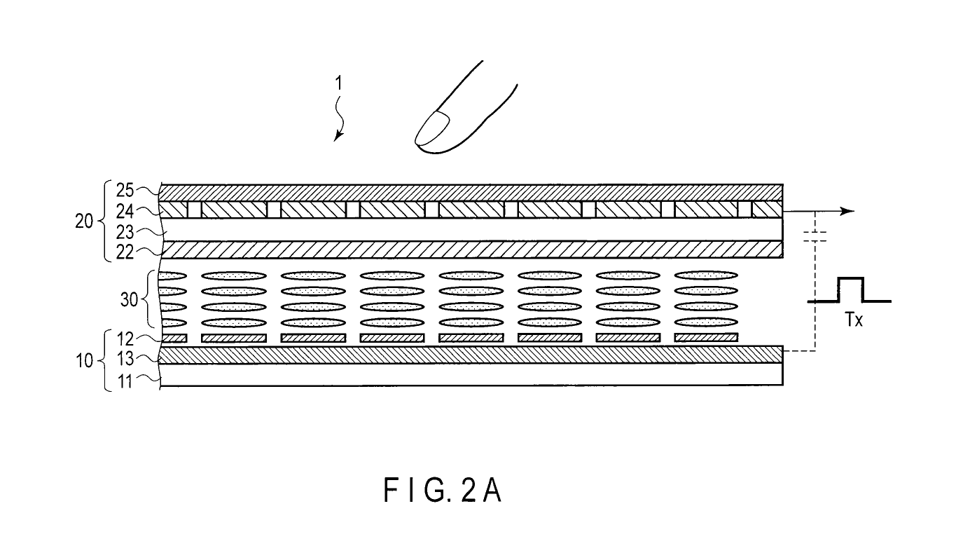

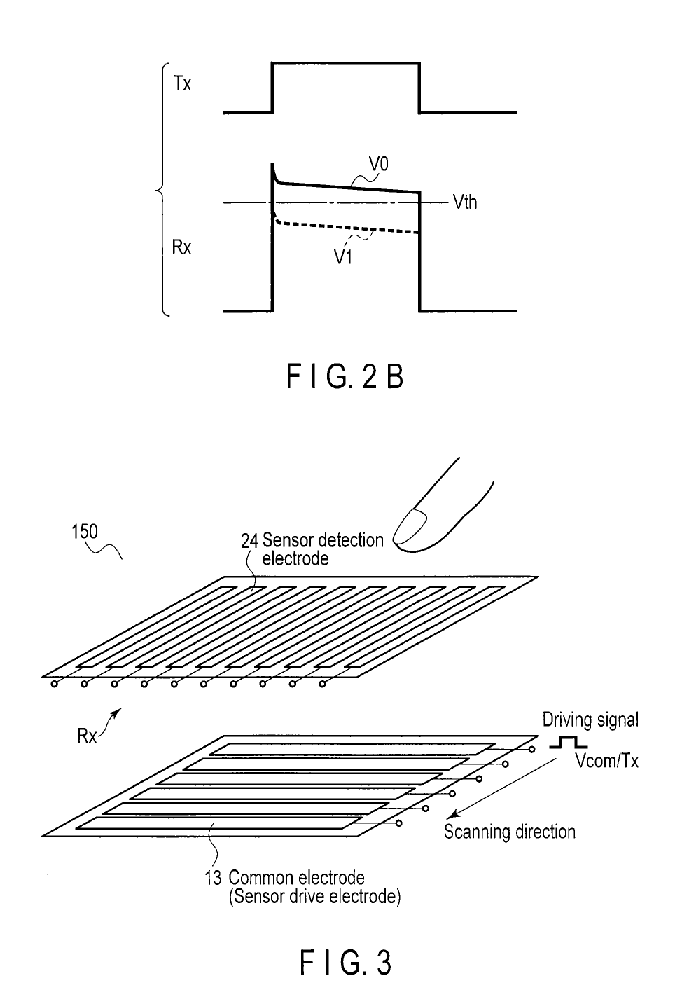

FIG. 2A is a cross sectional view of a basic structure of the sensor-integrated display device 100 in which the display element component 110 and the sensor component 150 are formed integrally, namely, a display device which includes the display panel and the operation input panel integrally.

An array substrate 10 is constituted by a common electrode 13 formed on a thin-film transistor (TFT) substrate 11 and a pixel electrode 12 formed above the common electrode 13 with an insulating layer interposed therebetween. A counter-substrate 20 is arranged opposite to and parallel to the array substrate 10 with a liquid crystal layer 30 interposed therebetween. In the counter-substrate 20, a color filter 22, a glass substrate 23, a sensor detection electrode 24 and a polarizer 25 are formed in order from the liquid crystal layer side.

The common electrode 13 is served as a drive electrode for a sensor (or a common drive electrode for a sensor) as well as a common drive electrode for display.

FIG. 2B shows a state of a voltage changed from V0 to V1 when a conductor, for example, a user's finger, has come close to an intersection of the common electrode and the sensor detection electrode, and the voltage is read from the intersection through the sensor detection electrode. In a state where the finger does not touch a touchpanel, a capacitance at the intersection is defined as a first capacitive element. Here, a current corresponding to the capacitance of the first capacitive element flows. A shape of potential on one end of the first capacitive element at this time looks like waveform V0 shown in FIG. 2B, for example. On the other hand, in a state where the finger comes close to the sensor detection electrode, a second capacitive element formed by the finger is added with the first capacitive element. In this state, in accordance with charging and discharging for the first capacitive element and the second capacitive element, currents flow through the first capacitive element and the second capacitive element, respectively. The shape of potential on the one end of the first capacitive element at this time looks like waveform V1 shown in FIG. 2B, for example, and this is detected by a detector. Here, the potential at the one end of the first capacitive element is a potential of the divided voltage which is defined by the values of currents that flow through the first capacitive element and the second capacitive element. Thus, waveform V1 takes on a smaller value than waveform V0 in a non-contact state. Accordingly, by comparing sensor signal Rx with threshold value Vth, it becomes possible to determine whether the finger is touching the touchpanel or not.

FIG. 3 is a perspective view illustrating the sensor component of the operation input panel and a method for driving the sensor component, and showing the relationship in arrangement between the sensor detection electrode 24 and the common electrode 13. The arrangement shown in FIG. 3 is an example and the operation input panel is not limited to this type.

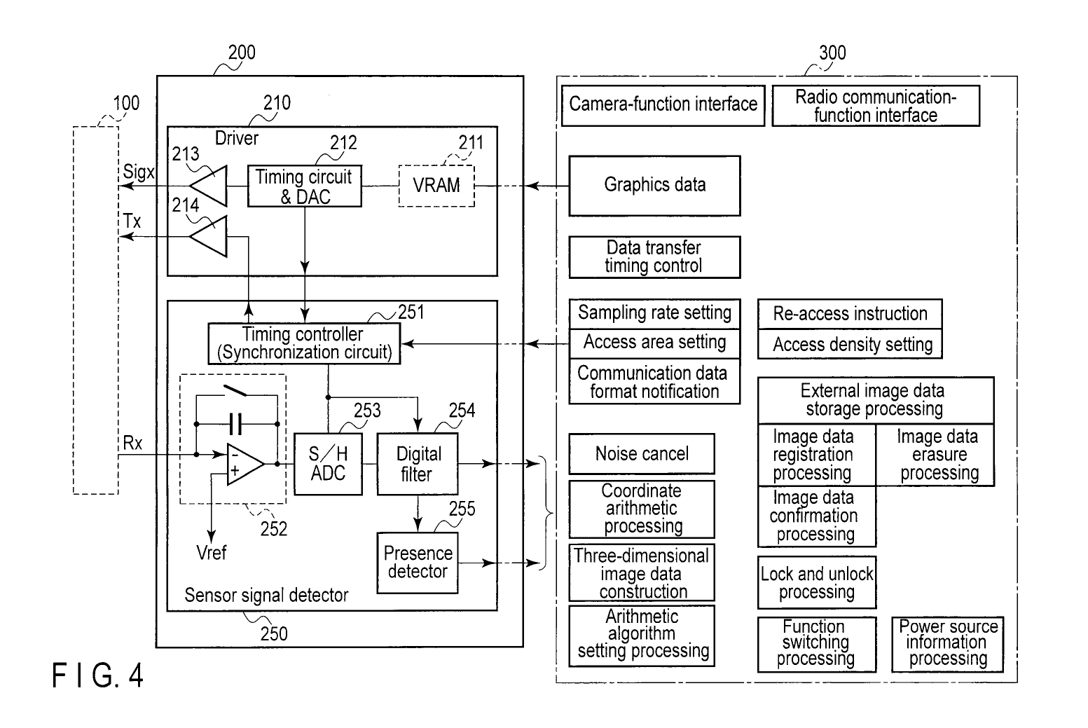

FIG. 4 is another view for illustrating the sensor-integrated display device 100, the data transfer device 200 and the application execution device 300.

Here, the figure further shows an example of the internal components of the data transfer device 200 and the application execution device 300.

The data transfer device 200 mainly includes the driver 210 and the sensor signal detector 250. The names of the driver 210 and the sensor signal detector 250 are not limited to these, and can be called an indicator driver IC and a touch IC, respectively. Though they are indicated as different elements in the block diagram, they can be formed integrally as one chip.

The driver 210 receives display data from the application execution device 300. The display data is time-divided and has a blanking period. The display data is input to a timing circuit and digital-to-analog converter 212 through a video random access memory (VRAM) 211 serving as a buffer. In the present system, the VRAM 211 may have the storage capacity of one frame or less.

Display signal SigX indicative of an analog quantity is amplified by an output amplifier 213 and input to the sensor-integrated display device 100 to be written to a display element. A blanking signal detected by the timing circuit and digital-to-analog converter 212 is input to a timing controller 251 of the sensor signal detector 250. The timing controller 251 may be provided in the driver 210 and called a synchronization circuit.

The timing controller 251 generates a driving signal for driving the sensor during a given period of the display signal (which may be a blanking period, for example). The driving signal is amplified by an output amplifier 214 and input to the sensor-integrated display device 100.

Driving signal Tx drives the sensor drive electrode to output sensor signal Rx from the sensor-integrated display device 100. Sensor signal Rx is input to an integrating circuit 252 in the sensor signal detector 250. Sensor signal Rx is compared with reference voltage (threshold) Vref in the integrating circuit 252, and sensor signal Rx at a level higher than a reference potential is integrated by a condenser, so that an integral output is obtained. Further, the condenser is reset for each detection unit period by a switch, and an Rx analog signal can be obtained. The output from the integrating circuit 252 is input to a sample-hold and analog-to-digital converter 253 and digitized. The digitized detection data is input to the application execution device 300 through a digital filter 254 as raw data.

The detection data is three-dimensional data (data of a plurality of bits) including both the detected data and non-detected data of an operation input. A presence detector 255 operates, for example, when the application execution device 300 is in a sleep mode and no coordinates of a touched position on the operation surface are detected. If there is any object close to the operation surface, the presence detector 255 can sense the object and turn off the sleep mode.

The application execution device 300 receives and analyzes the detection data, and can output the graphics data in accordance with a result of the analysis. Further, the application execution device 300 can switch the operating function of the system.

The application execution device 300 can deploy various applications to execute setting of an operating procedure of the device, switching of a function, generation and switching of a display signal, and the like. By using a sensor signal output from the sensor signal detector 250, the application execution device 300 can perform coordinate arithmetic processing and analyze an operating position. Since the sensor signal is captured as image data, three-dimensional image data can be constructed by an application. The application execution device 300 can also execute registration processing, erasure processing and confirmation processing, for example, for the three-dimensional image data. Furthermore, the application execution device 300 can lock or unlock the operating function by comparing the registered image data with the acquired image data.

When the sensor signal is acquired, the application execution device 300 can change the frequency of a driving signal output from the timing controller 251 to the sensor detection electrode and control the output timing of the driving signal. Accordingly, the application execution device 300 can switch a drive area of the sensor component 150 and set a driving speed of the same.

The application execution device 300 can also detect the density of the sensor signal and add additional data to the sensor signal.

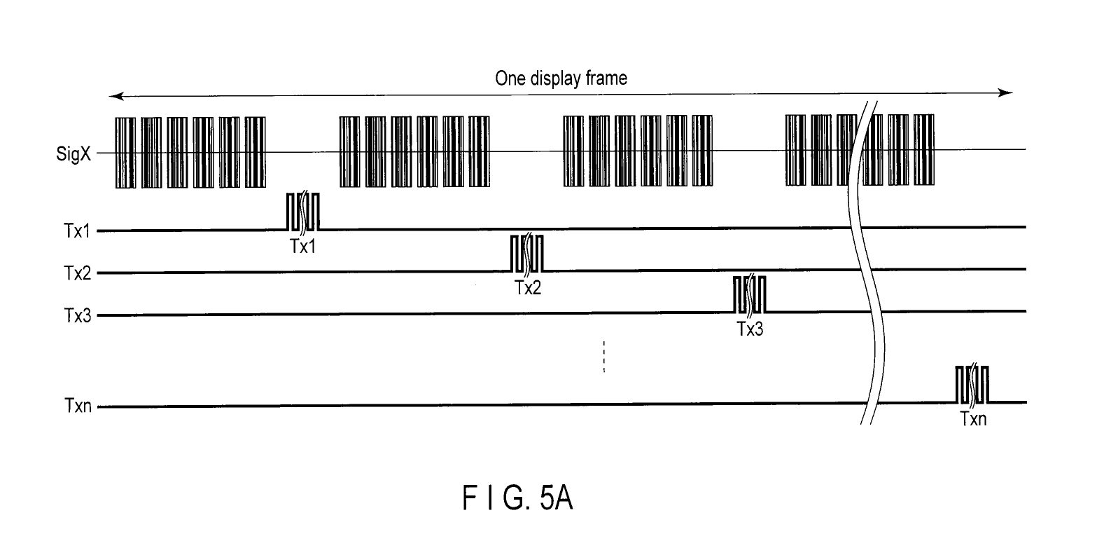

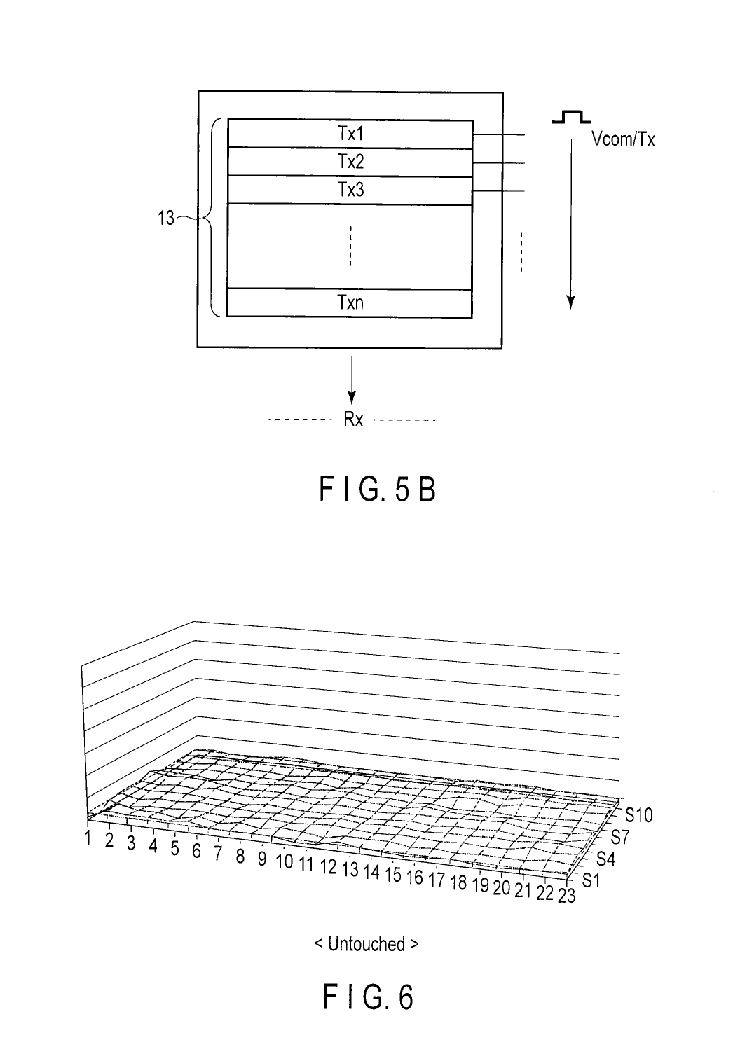

FIG. 5A shows an example of a timing chart between time-divided display data SigX and sensor driving signals Tx (Tx1-Txn) which are output from the data transfer device 200. FIG. 5B schematically shows the state of a two-dimensional scan performed by common voltage Vcom and sensor driving signals Tx in the sensor component 150 including the common electrode 13 and the sensor detection electrode 24. Common voltage Vcom is applied to the common electrode 13 in order. Further, driving signals Tx for obtaining a sensor signal in a given period are applied to the common electrode 13.

From the application execution device 300, display data SigX and sensor driving signals Tx may be input to the driver 210 via the same bus in a time-divided manner. Display data SigX and sensor driving signals Tx may be separated by the timing circuit and digital-to-analog converter 212. Sensor driving signals Tx are supplied to the common electrode 13 already described via the timing controller 251 and the amplifier 214. The timing at which sensor driving signals Tx are output from the timing controller 251, the frequency of sensor driving signals Tx, and the like can be changed by the instruction of the application execution device 300. Further, the timing controller 251 can supply a reset timing signal to the integrating circuit 252 of the sensor signal detector 250, and a clock to the sample-hold and analog-to-digital converter 253 and the digital filter 254.

FIG. 6 is a 3D graph showing an example of raw data on a sensor signal when no operation input is detected.

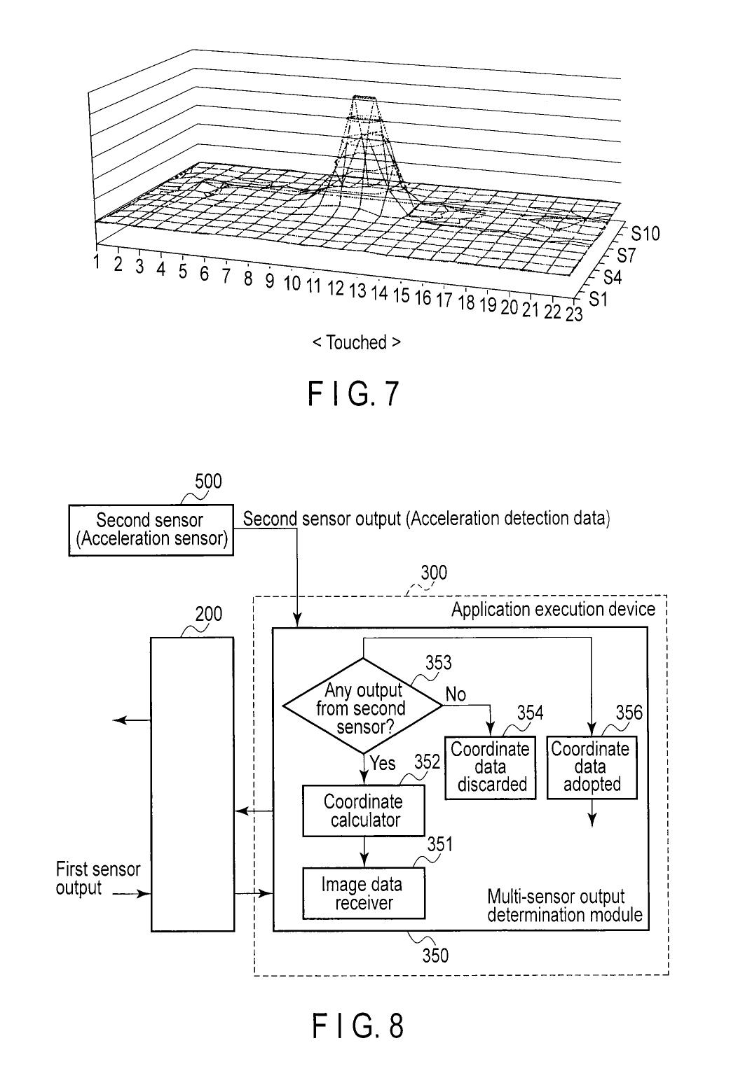

FIG. 7 is a 3D graph showing an example of raw data on a sensor signal when an operation input is detected.

In the above system, with respect to image data, the capacitance will be changed according to a distance between a target (for example, a user's finger), for example, and a touchpanel. Thus, the image data does not only represent its coordinate information but can also be treated as three-dimensional image data captured from a change in capacitance as the change in physical quantity.

Therefore, various kind of applications can be used in the application executing device, for example an application for recognizing a three-dimensional shape of an object, an application for recognizing a movement characteristics of an object when the object is moved on the touch panel, or the lick. If such applications are used, a threshold value can be set or varied to capture the three-dimensional image data. More specifically, in the mobile terminal, three-dimensional image data is transferred to the application executing device, and the three-dimensional image data can be modified into different forms, adjusted, changed or the like to use, thereby bringing about a number of advantages of recognition of three-dimensional distance, recognition of three-dimensional shape and the like.

The present device comprises a multi-sensor output determination module which switches the processing form of an output from a first sensor for detecting an input from the operation surface, in accordance with the condition of output from a second sensor.

FIG. 8 shows an example in which an acceleration sensor, for example, is provided as a second sensor 500. In the application execution device 300, a multi-sensor output determination module 350 is structured. Output data of the first sensor, which is output from the data transfer device 200, is received by an image data receiver 351, and a coordinate calculator 352 performs the coordinate calculation. Based on this coordinate calculation, a touched position on the operation surface can be specified. The second sensor 500 is an acceleration sensor, for example. A determination module 353 determines that a user has operated the operation surface when a sensor signal from the first sensor and acceleration detection data from the acceleration sensor are acknowledged. Especially, when an impulse output is obtained from the second sensor 500, it is possible to determine that a user has touched the operation surface and an impact was given. In order to reliably identify the impulse output from the second sensor 500, a condition that a pulse is not less than a threshold may be adopted. This condition should be adopted so as to eliminate an oscillating wave output from the second sensor 500 when the user is carrying the terminal with him/her while moving.

In the above case, a result of coordinate calculation is transmitted to a coordinate data adoption module 356 to be actually used. Here, when the acceleration detection data is not obtained from the acceleration sensor, the coordinate data which has been calculated is discarded by a discarding module 354.

By providing the multi-sensor output determination module 350, whether or not an operation input is made on the operation surface can be reliably determined by the second sensor 500. Accordingly, the application execution device 300 can be prevented from receiving an erroneous input and can process highly-reliable operation input information.

It should be noted that on/off, an operation mode, and the like of the second sensor 500 can be controlled by the application execution device 300.

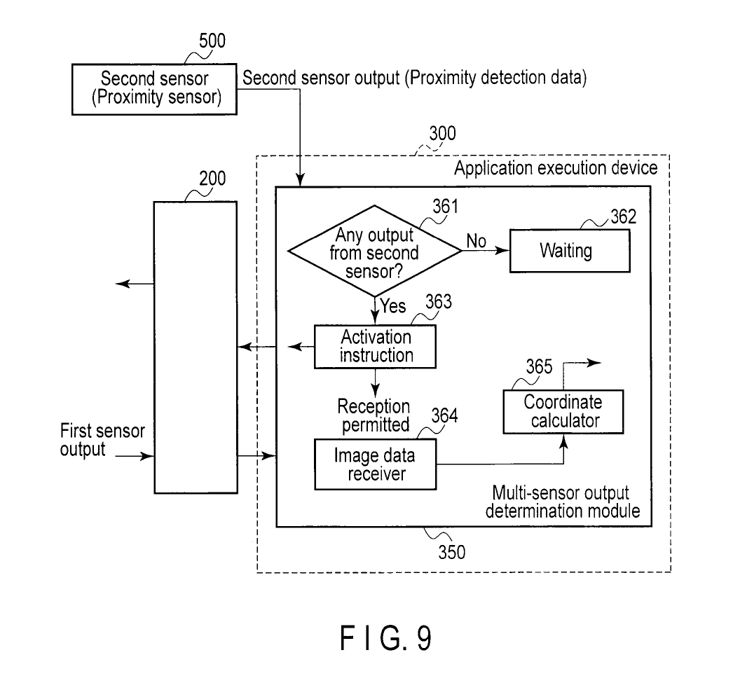

FIG. 9 shows another embodiment of the multi-sensor output determination module 350. In this embodiment, an infrared proximity sensor or a magnetic or electric field proximity sensor, for example, is used as a second sensor 500.

The proximity sensor can detect that a user has come close to the operation surface or an object which obstructs the magnetism or electric field has come close to the operation surface. If the user or the object comes close to the operation surface, a determination module 361 determines that some input operation will be started. Therefore, when detection data is input from the second sensor 500, the determination module 361 activates a data transfer device 200, for example, and starts operating an image data receiver 364, via an activation instructing module 363. Detection data from a first sensor received by the image data receiver 364 is thereby transmitted to a coordinate calculator 365. The determination module 361 controls the device to be in a standby state via a standby instructing module 362 when no detection signal is received from the second sensor 500.

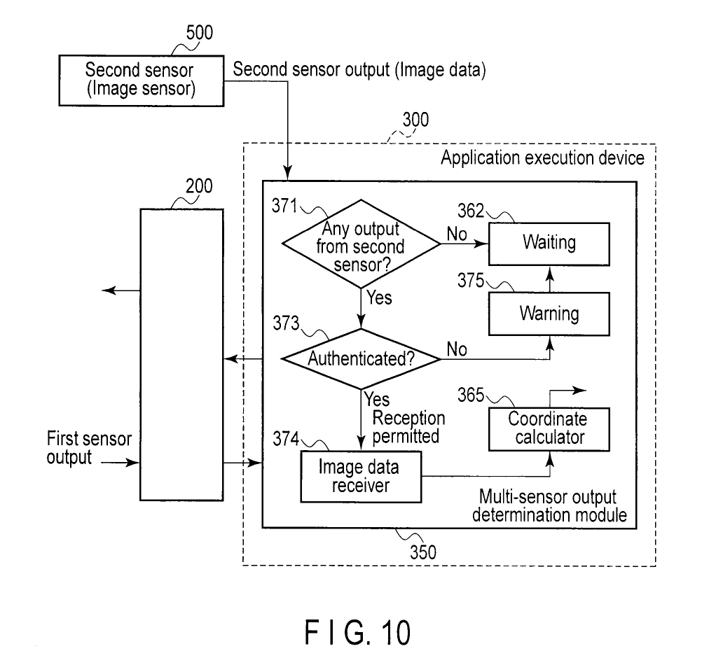

FIG. 10 shows yet another embodiment of the multi-sensor output determination module 350. In this embodiment, an imaging camera, for example, is used as a second sensor 500. The imaging camera can take in facial image data of a person facing the front side of the device. When the imaging camera captures the image data, a comparator 373 compares the captured image data with image data registered in advance. In this way, a specific user is authenticated. When an authorization signal is obtained as a result of the authentication, in an image data receiver 364, acceptance of operation inputs from the operation surface are started. Detection data from a first sensor received by the image data receiver 364 is thereby transmitted to a coordinate calculator 365. When authentication failed in a comparator 373, a warning (for example, an audio warning) is given by a warning module 365, and the device is shifted to a standby state.

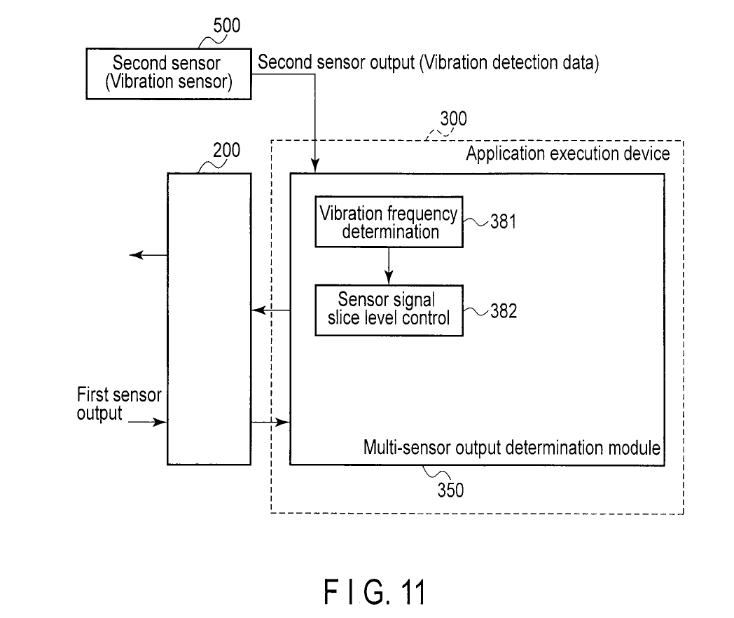

FIG. 11 shows yet another embodiment of the multi-sensor output determination module 350. In this embodiment, an acceleration sensor or a vibration sensor is used as a second sensor 500. Vibration detection data obtained from the vibration sensor is input to a vibration frequency determination module 381. For example, an operation input made by a stylus may be interrupted by specific strong vibrations. In such a case, measures for eliminating the interruption may be taken by adjusting a slice level of a sensor signal in accordance with vibrations of a specific frequency via a sensor signal slice level controller 382. For example, when continuous vibrations of a specific frequency are detected, a possibility is that a user is riding a vehicle having strong vibrations. In such a case, a mode can be switched to a countervibration input mode to work out the problem of interruption.

As the sensor, a sensor using a gyro, a gravity sensor, a pressure sensor, a temperature sensor, etc., may be used. Therefore, a plurality of sensor outputs from the above-mentioned sensors may be combined as the output from the second sensor. In addition, an output from the temperature or pressure sensor may be used as a source for issuing an alert or notifying emergency.

In the above, the structure in which the sensor-equipped display device comprises a liquid crystal display device as the display device has been described. However, the structure may be one including other display devices such as an organic electroluminescent display device. The example shown in FIG. 2A, etc., illustrates the structure of a liquid crystal display device in which both the pixel electrode and the common electrode are provided on the array substrate, namely, the structure in which a lateral electric field (including fringe field), for example, an In-plane Switching (IPS) mode or a Fringe Field Switching (FFS) mode, is mainly used. However, the structure of the liquid crystal display device is not limited to the above. It is also possible to arrange at least the pixel electrode to be provided on the array substrate, and the common electrode to be provided on either the array substrate or the counter-substrate. In the case of mainly using a vertical electric field, for example, a Twisted Nematic (TN) mode, an Optically Compensated Bend (OCB) mode, or a Vertically Aligned (VA) mode, the common electrode is provided on the counter-substrate. That is, the position where the common electrode is arranged may be any place as long as it is positioned between the insulting substrate which constitutes the TFT substrate and the insulating substrate which constitutes the counter-substrate.

The names of the blocks and components are not limited to those described above, nor are the units thereof. The blocks and components can be shown in a combined manner or in smaller units. The term “unit” may be replaced by terms such as “device”, “section”, “block”, and “module”. Even if the terms are changed, they naturally fall within the scope of the present disclosure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. Structural elements in the claims that are expressed in a different way, such as in a divided manner or in a combined manner, still fall within the scope of the present disclosure. In addition, claims directed to a method, a step, or a program, if any, are based on the device of the present embodiment. The accompanying claims and their equivalents are intended to cover such forms or modifications as would fall within the scope and spirit of the inventions.

What is claimed is:

1. An electronic device comprising:
a sensor-integrated display panel comprising an operation surface for giving an operation input to a first sensor and a display surface of an image integrally;
a data transfer device configured to input a driving signal for driving the first sensor to the sensor-integrated display panel and to output detection data corresponding to a potential of a sensor signal output from the first sensor; and
a multi-sensor output determination module configured to switch a processing form of the signal of the first sensor in accordance with a condition of output from a second sensor.

2. The electronic device according to claim 1, wherein
the second sensor is an acceleration sensor, and
the multi-sensor output determination module uses a result of coordinate calculation using detection data on the signal of the first sensor transmitted from the data transfer device, when the signal from the first sensor and the output from the second sensor are both acknowledged.

3. The electronic device according to claim 1, wherein
the second sensor is an acceleration sensor, and
the multi-sensor output determination module starts an operation corresponding to the signal of the first sensor, when the signal from the first sensor and the output from the second sensor are acknowledged.

4. The electronic device according to claim 1, wherein
the second sensor is a proximity detection sensor which detects that an object has come close to the operation surface, and
the multi-sensor output determination module starts processing of detection data of the first sensor, when detection data transmitted from the proximity detection sensor is input.

5. The electronic device according to claim 1, wherein
the second sensor is an imaging device which images an object which has come close to the operation surface, and
the multi-sensor output determination module starts authentication processing, when image data captured by the imaging device is input.

6. The electronic device according to claim 1, wherein the multi-sensor output determination module determines a frequency of the output from the second sensor, and controls the processing form of the signal of the first sensor in accordance with a result of the determination.

7. The electronic device according to claim 1, wherein the second sensor is a sensor controlled by an application execution device.

8. The electronic device according to claim 7, wherein an operation of the multi-sensor output determination module is executed by an application stored in the application execution device.

9. A method for controlling an electronic device comprising a sensor-integrated display panel comprising an operation surface for giving an operation input to a first sensor and a display surface of an image integrally, a data transfer device configured to input a driving signal for driving the first sensor to the sensor-integrated display panel and to output detection data corresponding to a potential of a sensor signal output from the first sensor, and an application execution device configured to control the sensor-integrated display panel and the data transfer device, the method comprising:
causing the application execution device to switch a processing form of the signal of the first sensor in accordance with a condition of output from a second sensor.

10. The method according to claim 9, further comprising using a result of coordinate calculation using detection data on the signal of the first sensor transmitted from the data transfer device, when the signal from the first sensor and an acceleration detection signal from the second sensor are both acknowledged.

11. The method according to claim 9, further comprising starting an operation corresponding to condition of output of the first sensor, when the signal from the first sensor and the output from the second sensor are acknowledged.

12. The method according to claim 9, further comprising starting authentication processing, when image data on an object which has come close to the operation surface is input.

13. The method according to claim 9, further comprising determining a frequency of the output from the second sensor, and controlling the processing form of the signal of the first sensor in accordance with a result of the determination.
